(19) United States
(12) Patent Application Publication
(10) Pub. No.: US 2014/0308953 A1
(43) Pub. Date: Oct. 16, 2014

(54) METHOD AND APPARATUS FOR MANAGING RADIO RESOURCES IN MULTI-CARRIER AND HETNET-INTEGRATED MOBILE ACCESS ENVIRONMENT

(71) Applicant: Electronics and Telecommunications Research Institute, Daejeon-si (KR)

(72) Inventors: Soon Gi PARK, Daejeon-si (KR); Young Jick BAHG, Daejeon-si (KR); Byung Han RYU, Daejeon-si (KR); Nam Hoon PARK, Daejeon-si (KR); Dong Seung KWON, Daejeon-si (KR)

(73) Assignee: Electronics and Telecommunications Research Institute, Daejeon-si (KR)

(21) Appl. No.: 14/101,998

(22) Filed: Dec. 10, 2013

(30) Foreign Application Priority Data
Apr. 11, 2013 (KR) 10-2013-0040081

(51) Int. Cl. H04W 36/30

(52) U.S. Cl. CPC H04W 36/30
USPC 455/436

(57) ABSTRACT

The present invention relates to a method and apparatus for managing radio resources in a multi-carrier and heterogeneous network-integrated radio access environment. A method of managing radio resources in a BS supporting multiple carriers includes sending an RRC connection reconfiguration message, including measurement control information, to UE, receiving a measurement report, including a measurement result for an HetNet RAT cell, from the UE, determining to configure HetNet RAT bearer connection with the UE based on the measurement report, sending an RRC connection reconfiguration message, requesting to configure the HetNet RAT bearer connection, to the UE, and sending some of or the entire traffic for the UE, to the UE through the HetNet RAT bearer. If overload or interference occurs in a serving cell, some of or the entire traffic is transmitted through a cell based on HetNet RAT, if necessary. Accordingly, load balancing or interference coordination can be achieved.

This application claims priority to and the benefit of Korean patent application number 10-2013-0040081 filed on Apr. 11, 2013, the entire disclosure of which is incorporated by reference herein, is claimed.

### BACKGROUND OF THE INVENTION

1. Field of the Invention

The present invention relates to wireless communication and, more particularly, to a method and apparatus for managing radio resources in a multi-carrier (or carrier aggregation) and heterogeneous network-integrated radio access environment.

2. Discussion of the Related Art

A multi-component carrier system means a wireless communication system capable of supporting a carrier aggregation. The carrier aggregation is technology in which fragmented small bands are efficiently used and one base station bundles a plurality of physically continuous or non-continuous bands in a frequency domain and freely uses the bundled bands on a larger band according to circumstances. The multi-component carrier system may also be called a multi-carrier system. The multi-component carrier system supports a plurality of Component Carriers (CCs) distinguished in a frequency domain. A CC includes an uplink CC used in uplink and a downlink CC used in downlink. A downlink CC and an uplink CC can be combined and used as one logical serving cell. Alternatively, only a downlink CC can be used as one logical serving cell.

Great communication demands can be generated in a specific area, such as a hot spot within a cell, and the reception sensitivity of radio waves can be deteriorated in a specific area, such as a cell edge or a coverage hole. With the development of wireless communication technology, small cells, for example, a pico cell, a femto cell, a micro cell, a Remote Radio Head (RRH), a relay, and a repeater are installed within a macro cell so that communication can be performed in areas, such as a hot spot, a cell edge, and a coverage hole. This network is called a Heterogeneous Network (HetNet). In an HeNet environment, a macro cell is a large cell having relatively large coverage, and a small cell, such as a femto cell or a pico cell, is a cell having small coverage. In an HeNet environment, coverage overlap occurs between a plurality of macro cells and small cells.

A mobile communication network service provider targets a network configuration and resource management in a single Base Station (BS) and single Radio Access Technology (RAT), and single system. Furthermore, an inter-system relation is set up under the assumption of loosely coupling performed in the rear of a terminal behind a network. All technical solutions, such as an HetNet, the deployment of hotspot cells, the use of a multi-component carrier (hereinafter referred to as a ‘multi-carrier’), and a BS form in which the signals of all cells are centralized and processed, are being sought due to a recent sharp increase of data resulting from the introduction of 3^{rd} Generation Partnership Project (3GPP) Long Term Evolution (LTE), and the expansion of investment and a reduction of incomes due to the sharp increase. However, a new mobile communication system environment is problematic in that existing resource management methods are used without change. Accordingly, there is a need for a new measurement and radio resource management method for supporting the existing resource management methods and a radio resource management method modified and expanded from the existing resource management methods.

### SUMMARY OF THE INVENTION

An object of the present invention is to provide a method and apparatus for managing radio resources in a mobile communication system environment.

Another object of the present invention is to provide a method and apparatus for managing radio resources in an integrated radio access environment.

Yet another object of the present invention is to provide a method and apparatus for managing radio resources in a multi-carrier system.

Further yet another object of the present invention is to provide a method and apparatus for managing radio resources in an HeNet environment.

Still yet another object of the present invention is to perform radio resource management in a multi-carrier and HetNet-integrated mobile access environment.

Still yet another object of the present invention is to provide service to UE through control between a plurality of systems in an HeNet environment.

Still yet another object of the present invention is to provide service to UE through a plurality of RATs.

In accordance with an aspect of the present invention, there is provided a wireless communication system for supporting heterogeneous (HetNet) Radio Access Technology (RAT). The wireless communication system includes an anchor system being a RAT system that is a criterion and for sending traffic to user equipment, checking information about at least one HetNet RAT system available for the user equipment, and controlling a connection configuration between the at least one HetNet RAT system and the user equipment; and the at least one HetNet RAT system for configuring connection with the user equipment based on control of the connection configuration of the anchor system and sending some of or the entire traffic for the user equipment, to the user equipment.

In accordance with another aspect of the present invention, there is provided user equipment supporting multiple carriers. The user equipment includes a reception unit for receiving an RRC connection reconfiguration message, including measurement control information, from a base station; a message processing unit for analyzing the measurement control information; a measurement unit for generating a measurement result for a cell based on HetNet RAT regarding the base station; and a transmission unit for sending a measurement report, including the measurement result, to the base station, wherein the reception unit receives an RRC connection reconfiguration message, requesting to configure HetNet RAT bearer connection with the user equipment, from the base station, the message processing unit configures the HetNet RAT bearer connection in the user equipment stage, and the reception unit receives some of or the entire traffic for the user equipment, from the base station through the HetNet RAT bearer.

In accordance with yet another aspect of the present invention, there is provided a method of managing radio resources in a base station supporting multiple carriers. The method includes sending an RRC connection reconfiguration message, including measurement control information, to user equipment; receiving a measurement report, including a measurement result for an HetNet RAT cell, from the user equipment; determining to configure HetNet RAT bearer connection with the user equipment based on the measurement report; sending an RRC connection reconfiguration message, requesting to configure the HetNet RAT bearer connection, to the user equipment; and sending some of or the entire traffic for the user equipment to the user equipment through the HetNet RAT bearer.

In accordance with further yet another aspect of the present invention, there is provided a method of managing radio resources in user equipment supporting multiple carriers. The method includes receiving an RRC connection reconfiguration message, including measurement control information, from a base station; sending a measurement report, including a measurement result for a cell based on HetNet RAT, to the base station; receiving an RRC connection configuration message, requesting to configure HetNet RAT bearer connection with the user equipment, from the base station; configuring the HetNet RAT bearer connection in the user equipment stage; and receiving some of or the entire traffic for the user equipment from the base station through the HetNet RAT bearer.

### BRIEF DESCRIPTION OF THE DRAWINGS

FIG. 1 shows a 3GPP LTE system;

FIG. 2 shows a cloud BS based on a 3GPP LTE system;

FIG. 3 shows basic forms for the deployment of cells for describing the present invention;

FIG. 4 shows a concept of a carrier aggregation for describing the present invention;

FIGS. 5 and 6 show examples of frameworks from a viewpoint of a carrier aggregation;

FIG. 7 shows an example of a new framework;

FIG. 8 shows an example of a bearer service structure according to the present invention;

FIG. 9 shows an example of scheduling according to the present invention;

FIG. 10 shows another example of scheduling according to the present invention;

FIG. 11 shows yet another example of scheduling according to the present invention;

FIG. 12 shows an example in which small cells based on RAT different from that of a macro cell are deployed in one macro cell;

FIG. 13 is a flowchart illustrating a radio resource management procedure in accordance with an embodiment of the present invention; and

FIG. 14 is a block diagram of UE and a BS for performing radio resource management in accordance with an embodiment of the present invention.

### DETAILED DESCRIPTION OF THE EMBODIMENTS

Hereinafter, in this specification, some exemplary embodiments of the present invention will be described in detail with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in this specification, a wireless communication network is described as a target, and tasks performed over the wireless communication network can be performed in a process in which a system (e.g., a base station) managing the wireless communication network controls the wireless communication network and sends data or can be performed by a terminal that accesses the wireless communication network.

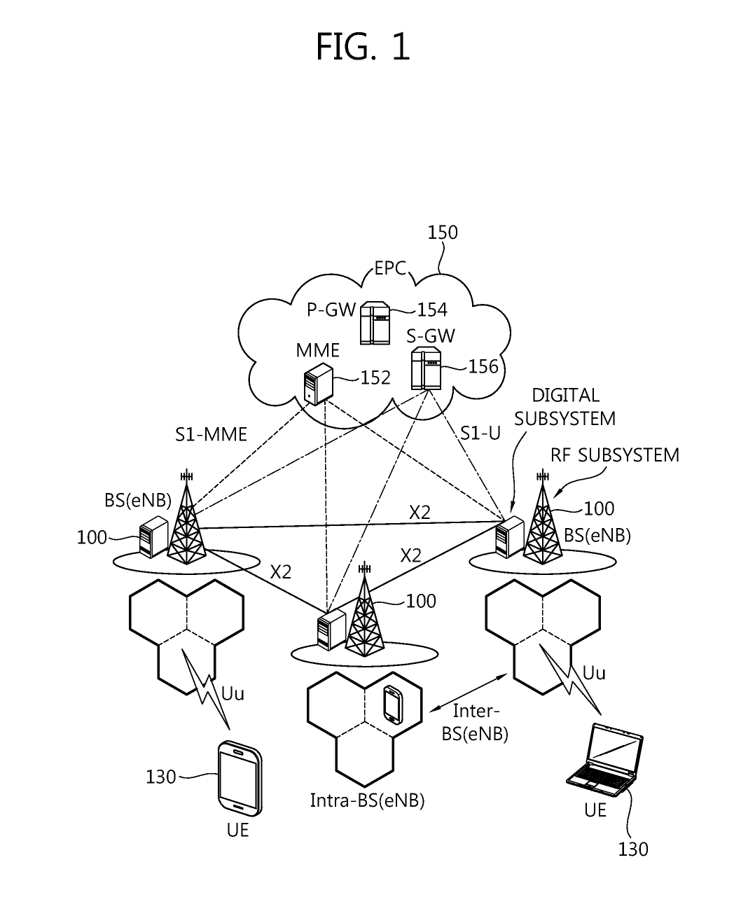

FIG. 1 shows a 3GPP LTE system. A 3GPP LTE system hereinafter can include a 3GPP LTE-Advanced (LTE-A) system.

Referring to FIG. 1, the 3GPP LTE system includes a Base Station (BS) 100 and an Evolved Packet Core (EPC) 150. The BS 100 commonly refers to a station that communicates with User Equipment (UE) 130. The BS 100 can also be called another term, such as evolved-NodeB (eNodeB or eNB), a Base Transceiver System (BTS), an access point, a femto-eNB, a pico-eNB, a Home eNB (HeNB), or a relay. The BSs 100 can be coupled through an X2 interface. The EPC 150 includes a Mobility Management Entity (MME) 152, a Packet Data Network-Gateway (P-GW) 154, and a Serving Gateway (S-GW) 156. The BS 100 is coupled with the EPC 150 through an S1 interface, more particularly, with the MME 152 through an S1-MME, and with the S-GW 156 through and an S1-U. The S1 interface exchanges pieces of Operation and Management (OAM) information for supporting a movement of the UE 130 by exchanging signals with the MME 152.

A radio interface between the UE 130 and the BS 100 is called a Uu interface. The layers of a radio interface protocol between the UE 130 and a network can be classified into a first layer L1, a second layer L2, and a third layer L3 based on 3 lower layers of an Open System Interconnection (OSI) reference model that is widely known in communication systems. From among the layers, a physical layer belonging to the first layer provides information transfer service using a physical channel, and a Radio Resource Control (RRC) layer placed in the third layer functions to control radio resources between the UE 130 and a network. To this end, the RRC layer exchanges RRC messages between the UE 130 and the BS 100.

An existing BS 100 is integrated with a Radio Frequency (RF) subsystem, and the one BS 100 can include (or manage) several cells. In this case, parts other than an RF subsystem in the BS 100 can be called a digital subsystem.

In the radio resource management of intra-BS (intra-eNB) cells, information about the cells may need to be shared. In the radio resource management of inter-BS (inter-eNB) cells, information messages between the BSs 100 may need to be exchanged. In the radio resource management of intra-BS cells, the BS 100 can perform rapid radio resource coordination through the sharing of information.

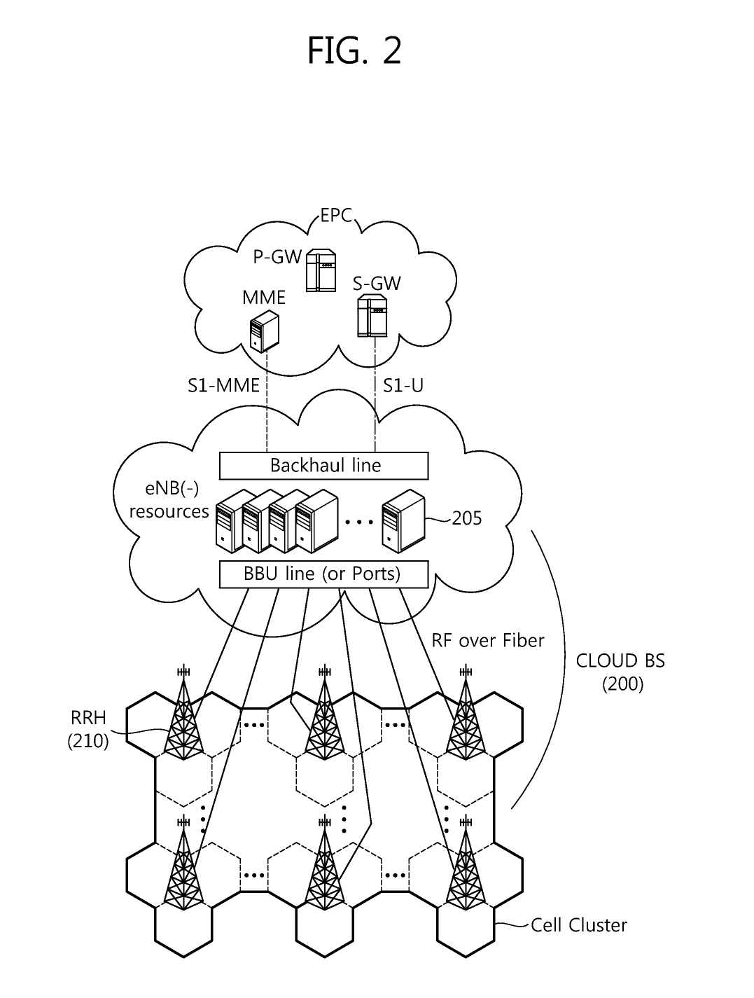

FIG. 2 shows a cloud BS based on a 3GPP LTE system.

FIG. 2 shows an example of a Cloud Base Station (CBS) 200 having a concept for processing a plurality of cell signals, wherein a Remote Radio Head (RRH) 210 reduced in size, integrated, and installed outdoors of an RF subsystem in an existing BS is deployed in an existing cell site and the digital subsystem 205 of the existing BS is deployed at one place. Integration control is possible as the number of cells included in the cloud BS 200 is increased, and target cells included in the cloud BS 200 may be homogeneous cells, heterogeneous cells, or overlapped cells.

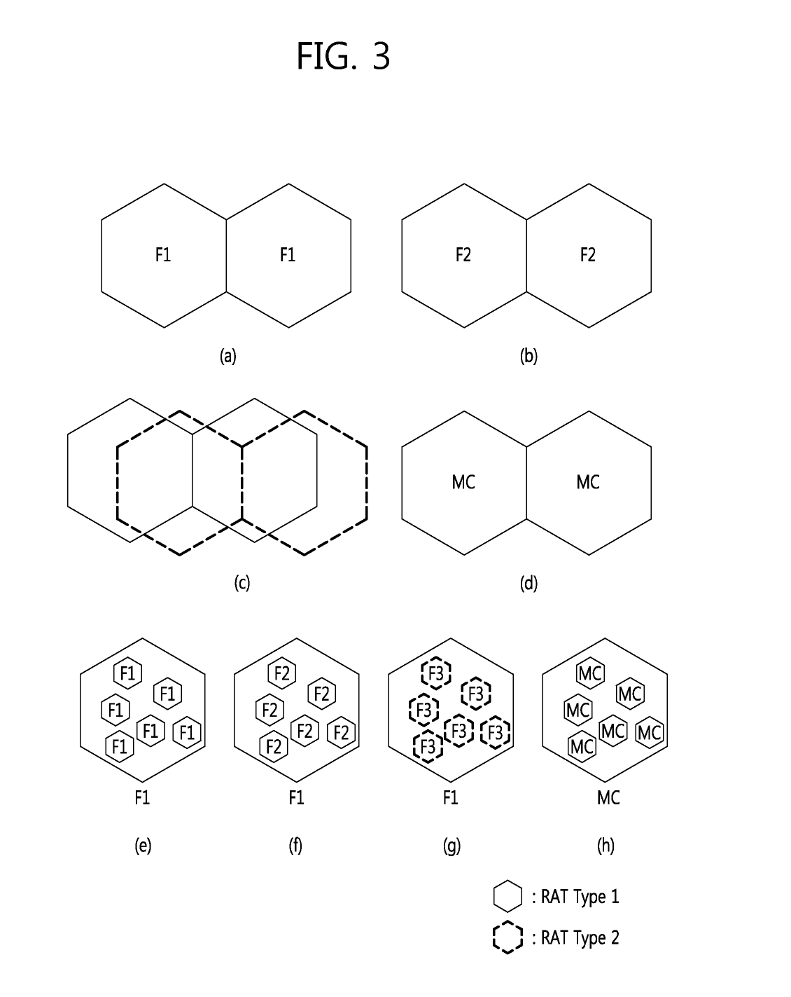

FIG. 3 shows basic forms for the deployment of cells for describing the present invention.

Referring to FIG. 3, (a) shows an example in which the operating frequencies of cells are separated and deployed (or managed) in order to prevent inter-cell frequency interference of an RAT type 1. For example, RAT type 1 can be any one of Wideband Code Division Multiple Access (WCDMA) technology, Wireless Broadband Internet (WIBRO) technology, and LTE communication technology.

(b) shows an example in which cells of RAT type 1 are deployed so that the cells have the same operating frequency (i.e., frequency use coefficient 1). In this case, in an LTE system, cells can be deployed in various ways, such as that the same allocated operating frequency is partitioned and deployed again.

(c) shows an example in which cells of RAT type 1 and cells of an RAT type 2 are overlapped with each other and deployed. For example, RAT type 1 can indicate LTE communication technology, and an RAT type 2 can indicate WIBRO communication technology. Alternatively, RAT type 1 may be WCDMA communication technology, and RAT type 2 may be LTE communication technology.

(d) shows an example in which multi-carrier cells are deployed in neighboring cell sites of RAT type 1.

(e) shows an example in which small cells (e.g., pico cells or femto cells) using the same RAT and operating frequency as a macro cell are deployed within one macro cell. In this case, interference between the macro cell and the small cells need to be coordinated.

(f) shows an example in which small cells using the same RAT as a macro cell, but using a different operating frequency from the macro cell are deployed within one macro cell. In this case, interference between the macro cell and the small cells can be disregarded.

(g) shows an example in which small cells using different RAT and different operating frequency from a macro cell are deployed within one macro cell. For example, the macro cell may be an LTE cell, and the small cell may be a Wi-Fi cell.

(h) shows an example in which the same RAT is used in a macro site in which multiple carriers are managed and small cells for operating the multiple carriers are deployed.

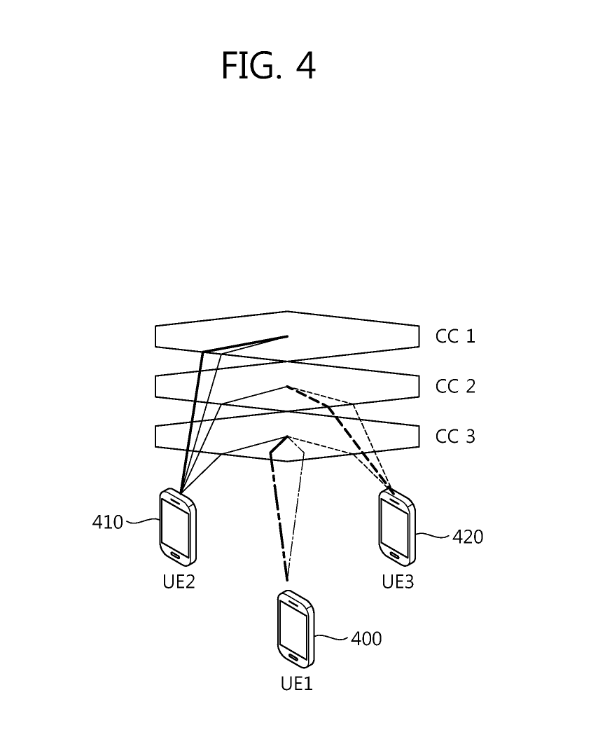

FIG. 4 shows a concept of a carrier aggregation for describing the present invention. FIG. 4 shows an example illustrating how a plurality of pieces of UE, for example, UE1 400, UE2 410, and UE3 420 is operated when multiple Component Carriers (CCs) are operated in one site.

Referring to FIG. 4, the UE2 410 is connected to a network in such a way as to use a CC1 as a primary component carrier and distribute traffic over the CC1, a CC2, and a CC3. The UE1 400 does not use multiple CCs, and the UE1 400 is connected to a network through only the CC3. The UE3 420 uses the CC2 as a primary component carrier and distributes traffic over the CC2 and the CC3. This distribution of the traffic is handled by the scheduler of a BS in 3GPP LTE. If different RATs are mixed as in FIGS. 3(c) and 3(g), there is a need for an integration scheduler for distributing traffic between HetNet RAT cells while operating in conjunction with the scheduler of each RAT. Alternatively, a cell having the largest coverage or a cell that can be accessed most easily may become an anchor cell, and the scheduler of the anchor cell may become a master and distribute traffic while operating in conjunction with the schedulers of different RATs.

In the case of a cell, cells can be deployed in various ways as shown in the examples of FIGS. 3(a) to 3(h). Furthermore, a BS can be an existing BS or a new cloud BS form, such as that shown in FIG. 1 or 2, or can have a form in which the existing BS and the cloud BS are combined. In this environment, the future mobile communication system will accommodate characteristics, such as inner-RAT and/or inter-RAT (HetNet) and a carrier aggregation. Hereinafter, the present invention proposes a method and apparatus for managing radio resources in this environment.

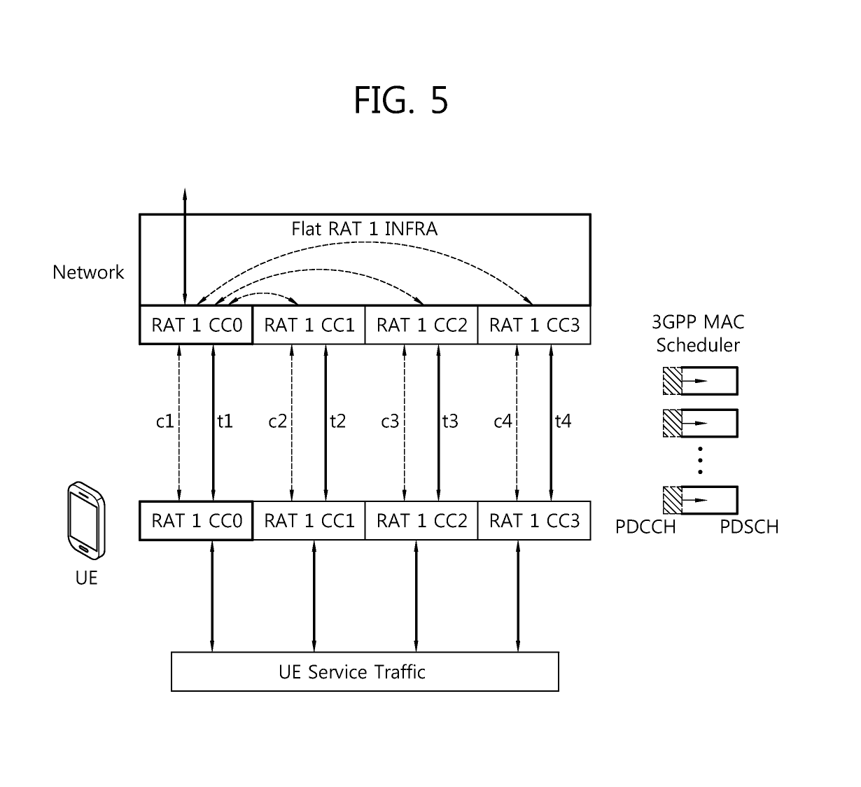

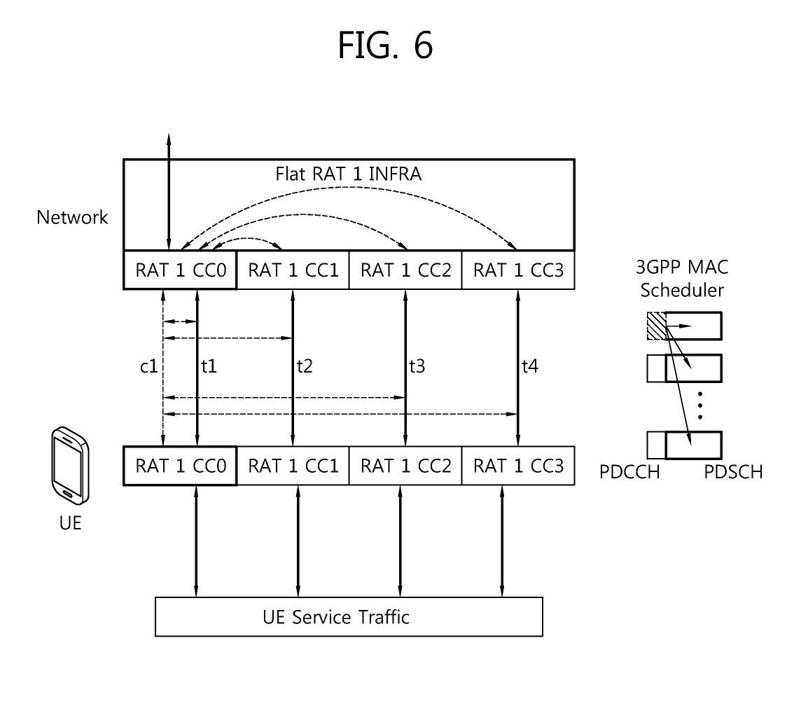

FIGS. 5 and 6 show examples of frameworks from a viewpoint of a carrier aggregation.

Referring to FIGS. 5 and 6, in an example of a carrier aggregation, a network BS L3 (i.e., a third layer) has rights to select an available CC. A scheduler has the final rights to the distribution of traffic over a CC determined to be used in the L3. For example, from a viewpoint of UE, a CC0 can be used as a primary component carrier, and a CC1, a CC2, and a CC3 can be used as secondary component carriers. In this case, for example, the UE monitors only the CC0 only when performing paging.

A physical downlink control channel (PDCCH), that is, one of physical control channels, informs UE of the resource allocation of a paging channel (PCH) and a downlink shared channel (DL-SCH) and Hybrid Automatic Repeat reQuest (HARQ) information related to the DL-SCH. A BS scheduler can independently operate a PDCCH in each CC as shown in FIG. 5. That is, the BS scheduler can perform scheduling so that the CC0, the CC1, the CC2, and the CC3 carry respective c1, c2, c3, and c4, that is, PDCCHs, and thus the c1, c2, c3, and c4 indicate different types of traffic t1, t2, t3, and t4 corresponding to the respective CCs for the UE. The different types of traffic can be mapped to the physical downlink shared channels (PDSCHs) of respective CCs.

Alternatively, the BS scheduler may perform scheduling so that any one of different types of traffic t1, t2, t3, and t4 corresponding to respective CC0, CC1, CC2, and CC3 for UE is indicated on the basis of a c1, that is, the PDCCH of the CC0, as shown in FIG. 6. If a PDCCH and data traffic are transmitted through a different CC and a PDCCH indicates data traffic included in a different CC as in the example of FIG. 6, it may be called cross-carrier scheduling.

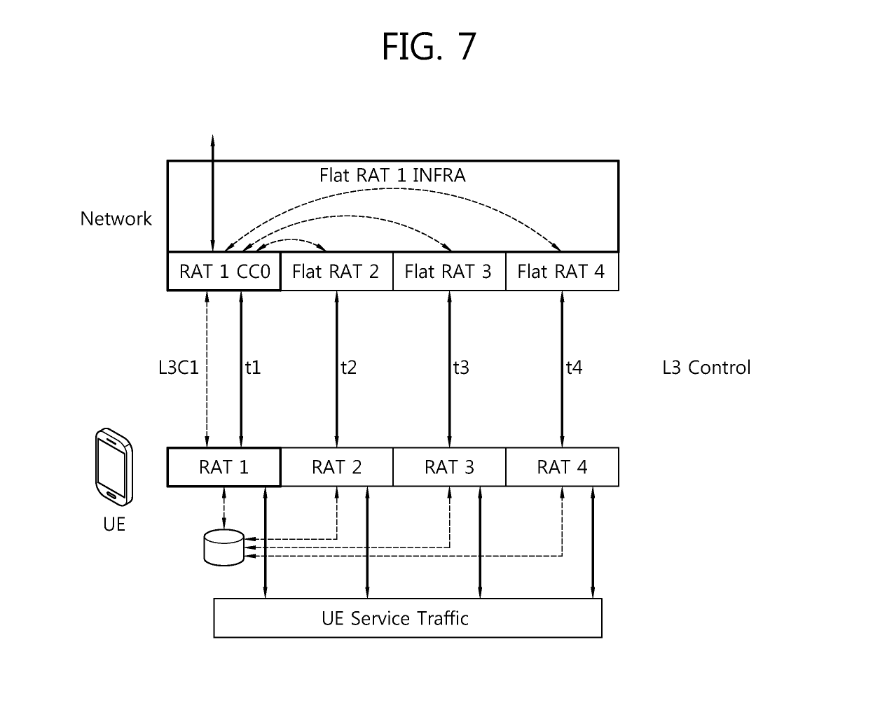

FIG. 7 shows an example of a new framework. In FIG. 7, the new framework can also be applied to the cloud BS system of FIG. 2. The new framework can be applied from a viewpoint of the carrier aggregation of the same RAT, but may be used from a viewpoint of different RAT cell aggregations, such as those shown in FIGS. 3(c) and 3(g).

Referring to FIG. 7, from a viewpoint of a network, RAT1 can be handled as a basis for all system, and RAT2, RAT3, and RAT4 can be handled as flat RATs (i.e., a flat RAT2, a flat RAT3, and a flat RAT4). In this case, traffic can be delivered based on RAT1 infra (e.g., an EPC). This RAT1 infra system, that is, a basis, can be seen as an anchor system. This RAT1 can be previously defined, or RAT included in a cell that can be always connected or can provide the best service from a viewpoint of coverage can become RAT1. Here, it is assumed that a 3GPP LTE infra system is an anchor system. Downlink traffic to UE is transmitted from an EPC to a BS (or eNB) that manages the cell of RAT1 in a bearer form or can be transmitted from the BS to the UE through at least one of the cells of RAT1, RAT2, RAT3, and RAT4. Furthermore, uplink traffic can be transmitted through at least one of the cells of RAT1, RAT2, RAT3, and RAT4 and then transmitted to an upper stage through RAT1 infra. In this case, the selection of the cells of different RATs and the connection of the traffic can be performed through the exchange of L3 messages, that is, L3C1 of RAT1. The L3C1 may also be called an HetNet RAT connection configuration message. For example, if an anchor system is a 3GPP LTE system, the L3C1 can be an RRC connection reconfiguration message.

Accordingly, in accordance with an example of the present invention, the basic infra of RAT1 is used without change, and a BS and/or UE can check information about HetNet RATs that can be used in a current position of UE when the UE moves and can perform a task for coupling the HetNet RATs through the exchange of L3 messages, that is, the L3C1 of RAT1. In this case, control and traffic information in different HetNet RAT other than RAT1 can be exchanged in the same manner as an existing method, and the selection of the different HetNet RAT and a task for coupling the different HetNet RAT with existing infra are realized through a control message, that is, L3C1 of RAT1. That is, radio information about different RAT is collected from UE through the signaling of an anchor system, and available different RAT is optimally selected by a network so that traffic can be transmitted and received.

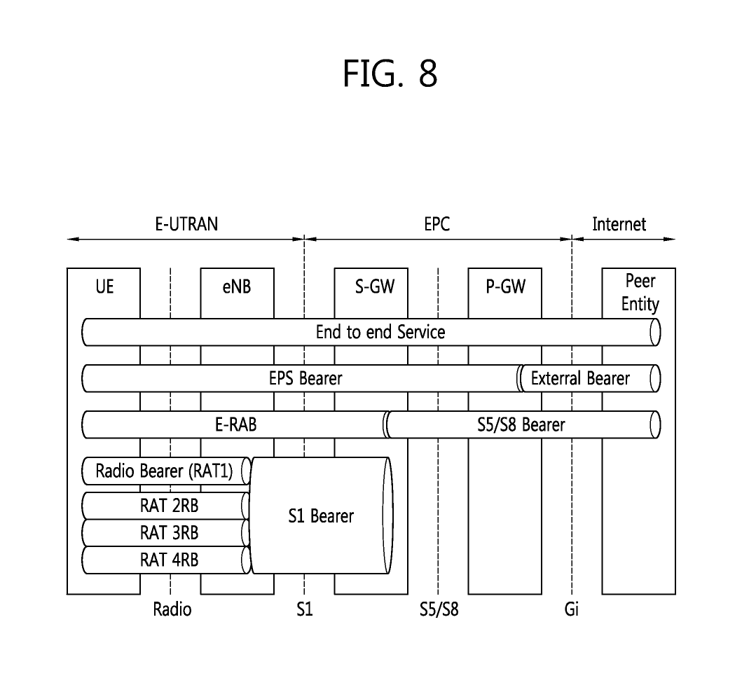

FIG. 8 shows an example of a bearer service structure according to the present invention. FIG. 8 shows a case where RAT1 is 3GPP LTE. In FIG. 8, in the eNB of one anchor system, a radio bearer (i.e., RAT1 RB) is always mapped to an S1 bearer in a one-to-one manner, but HetNet RATs are integrally managed in the eNB of the anchor system. Accordingly, a function of mapping a data path, provided by different RAT, to the S1 bearer by handling the data path as an RAT 2 RB, an RAT 3 RB, and an RAT 4 RB can be provided.

Referring to FIG. 8, the Radio bearer (RB) is provided by a Uu interface in order to support user service. In 3GPP LTE, each bearer is defined in each interface in order to guarantee independency between interfaces.

A bearer provided by a 3GPP LTE system is called an Evolved Packet System (EPS) bearer as a generic term. The EPS bearer is classified into an RB, an S1 bearer, and an S5/S8 bearer according to each interface.

A Packet Gateway (P-GW) is a network node that couples an LTE network and a different network. The EPS bearer is defined between UE and the P-GW. The EPS bearer is subdivided between nodes. The RB is defined between the UE and the eNB, the S1 bearer is defined between the eNB and the S-GW, and the S5/S8 bearer is defined between the S-GW and the P-GW within an EPC.

The S1 bearer of an LTE eNB which supports a framework, such as that of FIG. 7, can be connected to the RAT1 RB and can also be multi-mapped and connected to the RAT2 RB, RAT3 RB, and RAT4 RB. In FIG. 6, as a concept called cooperative transmission between CCs in the same RAT, the subject that selects a CC when cooperative transmission is performed is an L3 function in LTE(-Advanced) criterion, and the subject that actually sends a packet is the L2 scheduler. In FIG. 7, one entire anchor system is used between the CCs of different RATs. Furthermore, different RAT is selected through signaling in an anchor in such a manner that only a radio access part is flat, information toward a core is collected, an anchor eNB selects and provides available radio access to UE according to circumstances, and connection with an anchor core network is used as connection with a core network.

Meanwhile, an eNB can manage information about frequency of resources usage in a multi-carrier environment or available HetNet cell environment. The eNB manages the frequency of resources usage on the basis of at least one of a site unit, a carrier unit, and UE unit. That is, the eNB can manage the frequency of resources usage according to the site, the carrier, and the UE. In this case, the eNB can divide the frequency of resources usage into frequency of primary resource usage and frequency of secondary resource usage. The frequency of primary resource usage can indicate a degree that UE uses resources in a primary component carrier, and the frequency of secondary resource usage can indicate a degree that UE uses resources in a secondary component carrier. Furthermore, an eNB that manages a neighboring cell (e.g., a neighboring macro cell or a small cell) can manage frequency of resources usage, and the frequency of resources usage can be shared between eNBs. Information about the frequency of resources usage (hereinafter referred to as ‘resource usage information’) can be used for a multi-carrier operation for distributing a load in the same site or for a multi-carrier operation in which interference between the cells of different sites is taken into consideration. Pieces of the resource usage information can be exchanged between eNBs (i.e., inter-eNB) or cloud eNBs (i.e., inter-cloud eNB) in a message form through an X2 interface or means equivalent to the X2 interface. Pieces of the resource usage information may not need to be exchanged in an intra-eNB (or intra-cloud eNB), or (e.g., if the resource usage information is shared in itself), pieces of the resource usage information can be rapidly exchanged through an internal line.

(Uplink or downlink) resource usage information managed by an eNB can include the following contents, for example.

TABLE 1

| | | | Macro a (site) | | |
|---|---|---|---|---|---|
| | Macro a (site) | | Primary | Secondary | Total |
| | Primary | Secondary | (total) | (total) | CC Usage |
| CC1(F1) | UE2map1 | | Total P. | Total S. | Total CC1 |
| | (20) | | CC1 | CC1 | Usage(20) |
| | | | Usage(20) | Usage(0) | |
| CC2(F2) | UE3map2 | UE2mas2 | Total P. | Total S. | Total CC2 |
| | (50) | (50) | CC2 | CC2 | Usage(100) |
| | | | Usage(50) | Usage(50) | |
| CC3(F3) | UE1map3 | UE2mas3 | Total P. | Total S. | Total |
| | (20) | (50) | CC3 | CC3 | CC3 |
| | | UE3mas3 | Usage(20) | Usage(70) | Usage(90) |
| | | (20) | | | |
| CC4(F4) | None | None | Total P. | Total S. | Total |
| | | | CC4 | CC4 | CC4 |
| | | | Usage(0) | Usage(0) | Usage(0) |

Referring to Table 1, the eNB manages frequency of resources usage according to a site, a CC, and UE and manages a primary component carrier and a secondary component carrier separately. The example of Table 1 can be applied to a case where the UE1, the UE2, and the UE3 are operated in a macro site in FIG. 4.

More particularly, the UE2map1(20) indicates that the UE2 uses the CC1(F1) as a primary component carrier in the macro site and uses resources of 20% of all available resources in the CC1(F1). The UE3map2(50) indicates that the UE3 uses the CC3(F5) as a primary component carrier in the macro site and uses resources of 50% of all available resources in the CC2(F2). The UE2mas2(50) indicates that the UE2 uses the CC2(F2) as a secondary component carrier in the macro site and uses resources of 50% of all available resources in the CC2(F2). The UE1 map3(20) indicates that the UE1 uses the CC3(F3) as a primary component carrier in the macro site and uses resources of 20% of all available resources in the CC3(F3). The UE2mas3(50) indicates that the UE2 uses the CC3(F3) as a secondary component carrier in the macro site and uses resources of 50% of all available resources in the CC3(F3). The UE3mas3(20) indicates that the UE3 uses the CC3(F3) as a secondary component carrier in the macro site and uses resources of 20% of all available resources in the CC3(F3).

Furthermore, the eNB can check a degree that resources are used as a primary component carrier in each CC and a degree that resources are used as a secondary component carrier in each CC. Particularly, Total P.CC1 Usage( ) indicates a degree that the CC1 is used as a primary component carrier, which can be indicated by the sum of UExmap1(value)s. Here, the UEx can be the UE1, the UE2, or the UE3. Total S.CC1 Usage( ) indicates a degree that the CC1 is used as a secondary component carrier, which can be indicated by the sum of UExmas1(value)s. Total P.CC2 Usage( ) indicates a degree that the CC2 is used as a primary component carrier, which can be indicated by the sum of UExmap2(value)s. Total S.CC2 Usage( ) indicates a degree that the CC2 is used as a secondary component carrier, which can be indicated by the sum of UExmas2(value)s. Total P.CC3 Usage( ) indicates a degree that the CC3 is used as a primary component carrier, which can be indicated by the sum of UExmap3(value)s. Total S.CC3 Usage( ) indicates a degree that the CC3 is used as a secondary component carrier, which can be indicated by the sum of UExmas3(value)s.

Furthermore, the eNB can also check a degree that resources are now used in each CC. Particularly, Total CC1 Usage( ) indicates that the CC1 is used, which can be indicated by the sum of Total P.CC1 Usage( ) and Total S.CC1 Usage( ) Total CC2 Usage( ) indicates that the CC2 is used, which can be indicated by the sum of Total P.CC2 Usage( ) and Total S.CC2 Usage( ) Total CC3 Usage( ) indicates that the CC3 is used, which can be indicated by the sum of Total P.CC3 Usage( ) and Total S.CC3 Usage( ).

The resource usage information can be represented in a form, such as Physical Resource Block (PRB) usage in the case of LTE(-Advanced). The eNB can be aware that, for example, the UE1 connects to only the CC3 and transmits (or receives) traffic without performing a Carrier Aggregation (CA), based on the resource usage information. The eNB can also be aware that the UE2 uses the CC1 as a primary component carrier and performs transmission (or reception) by distributing traffic over the CC1, the CC2, and the CC3. Furthermore, the eNB can be aware that the UE3 uses the CC2 as a primary component carrier and performs transmission (or reception) by distributing traffic over the CC2 and the CC3. The eNB may use the resource usage information to manage interference. The example of Table 1 indicates information managed in the same macro site, but the example can be equally applied to a multi-carrier environment including a small site (or cell), such as FIG. 3(h).

For example, in the environment of FIG. 3(d) or 3(h), when UE performs initial access, the resource usage information can be used as follows. If Total CC Usage of a CC to which the UE has performed initial access is high and Total S. CC Usage is high, an eNB can search for pieces of UEs that use secondary component carriers (S. CCs) relatively a lot, list (or order) the pieces of UE, search the pieces of UEs for UE capable of performing a CA to a different CC, and distribute traffic to the different CC. In this case, the eNB can search for a CC having low frequency of usage by the UE and distribute the traffic of pieces of UE capable of performing a CA to the CC.

Furthermore, if a CC to which UE has performed initial access does not accommodate new UE because the Total CC Usage of the CC is too high, the eNB can send an access reject message to the UE. In this case, the eNB can include a Redirection Info. Field in the Information Element (IE) of the access reject message, and the Redirection Info. Field can designate another CC to which the UE can access. In this case, the eNB can designate another CC having a small load based on the resource usage information.

Furthermore, if an eNB needs to provide additional traffic to UE, for example, UE connected to a specific CC requires additional traffic, the eNB can designate another CC as a Secondary Component Carrier (S. CC) when Total CC Usage for the connected CC is a specific threshold TH1 or higher. In this case, the eNB can designate a CC having the smallest Total CC Usage or a specific threshold TH2 or lower as another CC. If a plurality of CCs having an equal level is present, the eNB can designate a CC having higher Total S. CC Usage as another CC according to an additional criterion. Alternatively, the eNB can designate a CC having a small number of pieces of UE, connected to the eNB per CC, as another CC according to an additional criterion.

Meanwhile, if interference is generated in a specific carrier of multiple CCs configured in a specific site, an eNB can perform interference coordination based on the resource usage information.

For example, an eNB can search for pieces of UE that use a carrier (i.e., a victim cell) in which interference has occurred as a secondary component carrier and sequentially move the traffic of the pieces of UE to carriers having relatively smaller loads.

For another example, an eNB can search for UE that now performs a CA including a carrier in which interference has occurred, perform control so that a minimum signal is carried on the carrier, and move various types of remaining traffic to carriers having relatively small loads.

For yet another example, an eNB can search for pieces of UE that use a carrier in which interference has occurred as a primary component carrier (and a single carrier). If UE that does not perform a CA is present in the pieces of retrieved UE, the eNB can search for a carrier most suitable for the UE, add the retrieved carrier as a secondary component carrier, and perform control so that the traffic of the UE is carried on the secondary component carrier.

For still another example, an eNB may search for pieces of UE that use a carrier in which interference has occurred as a primary component carrier (and a single carrier) and handover the pieces of retrieved UE to other carriers.

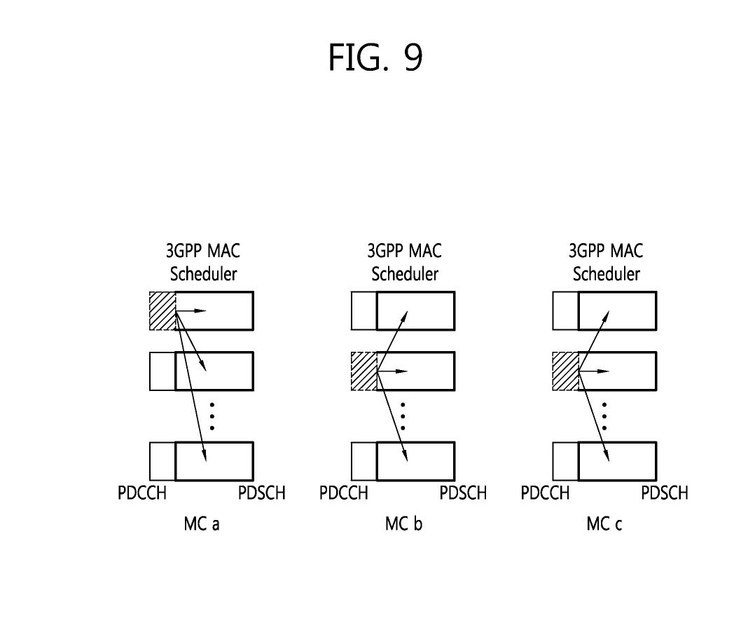

FIG. 9 shows an example of scheduling according to the present invention.

Referring to FIG. 9, if cross-carrier scheduling is possible, a BS can deploy main carriers (i.e., primary component carriers) alternately so that PDCCH interference can be avoided between carriers that operate in different site. For example, when the deployment of sites (or cells) of FIG. 3(d) or 3(h) is taken into consideration, a BS (particularly, scheduler) can control adjacent or overlapping carriers so that primary component carriers for pieces of UE do not overlap with each other. In this case, interference can be avoided in an environment in which interference can be generated when carriers are geographically adjacent to each other or overlapped with each other because frequency bands are the same or similar. Information about a main carrier that will generally control the multi-component carrier control signals of each site needs to be shared between sites (particularly, BSs that operate wireless communication service in the sites).

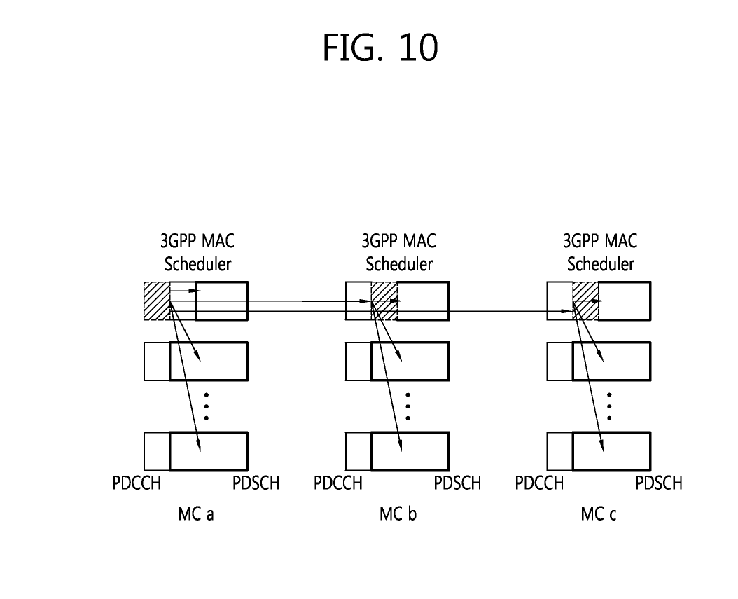

FIG. 10 shows another example of scheduling according to the present invention. FIG. 10 shows examples in which control channel interference is avoided when small sites are present within a macro site as shown in FIG. 3(h) in a multi-component carrier environment.

Referring to FIG. 10, a BS designates a control part (e.g., virtual PDCCH) for small sites in which one CC of a macro site is placed within the macro site in the PDSCH regions of the respective small sites through the PDCCH of the CC within the macro site and does not allocate data to the PDSCH regions of the macro site that correspond to the respective PDSCH regions of the small sites to which the control part for the small sites is mapped. Here, it is assumed that CCs having the same frequency are not overlaid between the small sites. In this case, the PDSCH regions (i.e., virtual PDCCH regions) of small sites designated as a control part by the PDCCH of a macro site can be the same. The carrier of a small site can be subject to cross-carrier scheduling on multiple component carriers based on the virtual PDCCH. For example, assuming that a carrier of the macro site including the PDCCH is a primary component carrier, the primary component carrier can perform cross-carrier scheduling on a plurality of carriers of the small site through the virtual PDCCH.

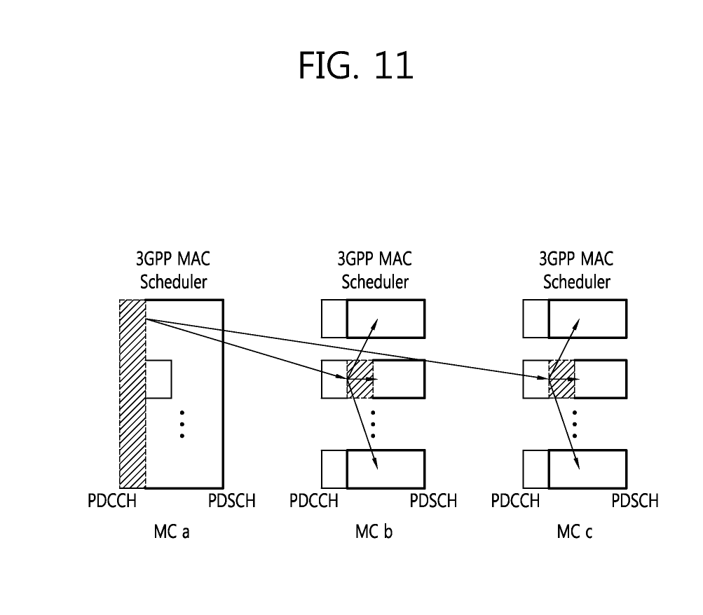

FIG. 11 shows yet another example of scheduling according to the present invention. FIG. 11 shows an example in which small sites are present within a macro site as shown in FIG. 3(h) and control channel interference is avoided in a multi-component carrier environment. Furthermore, in FIG. 11, it is assumed that the carrier of the macro site operates as a single carrier having a bandwidth of 20 MHz and the carriers of the small sites operate as 4 multiple carriers each having a bandwidth of 5 MHz.

Referring to FIG. 11, a BS indicates (or defines) a control part for all the small sites, that is, a virtual PDCCH, through the PDCCH of the carrier of the macro site and performs control so that data is not allocated to the virtual PDCCH region. Furthermore, the PDCCH regions of the carrier of the macro site are made empty in the small sites. Furthermore, the small sites can perform cross-carrier scheduling on multiple component carriers based on the virtual PDCCH. In this case, when important information, such as a System Information Block (SIB), is scheduled, an available frequency is basically partitioned in order to avoid a collision between carriers that operate between a macro site and small sites. Furthermore, in this case, in the carrier of the macro site, data is not allocated to a region corresponding to the scheduling region of the SIB for the carriers of the small sites in order to avoid a collision between the SIBs.

Meanwhile, resource management in a framework according to the present invention can be performed as follows, for example. This example can be applied to a framework, such as that shown in FIG. 7. This example can also be applied to a cloud BS system, such as that shown in FIG. 2. Furthermore, this example may be applied to an HetNet RAT overlap cell, such as those shown in FIG. 3S (c) and (g).

Referring back to FIG. 7, in a cloud BS system, such as that shown in FIG. 2, an RAT1 infra-network can instruct a request to collect information about the cells (or carriers) of flat RAT2, flat RAT3, and flat RAT4 in the form of an L3C1 message (e.g., RRC connection reconfiguration message), that is, an HetNet RAT connection configuration message, through RAT1. UE can report an accessible radio state for the RAT1, RAT2, RAT3, and RAT4 of the UE itself and an available radio resource state to the RAT1 infra-network through RAT1 based on the L3C1 message received through RAT1. The RAT1 infra-network can collect information (e.g., at least one of an accessible radio state, an available radio resource state, and UE mobility information) about UE that has accessed a cell (or carrier) managed by the RAT1 infra-network and update the collected information.

Furthermore, the RAT1 infra-network can manage access through the L3C1 message so that a Radio Bearer (RB) for HetNet RATs (e.g., RAT2, RAT3, and RAT4) can be mapped to the bearer service structure of the RAT1 infra-network. In this case, as can be seen from FIG. 8, a (downlink) packet transmitted from a peer entity to UE is delivered to a BS through an external bearer coupled between the peer entity and a P-GW, an S5/S8 bearer coupled between the P-GW and an S-GW, and an S1 bearer coupled between the S-GW and the BS (or eNB). At least one of an RAT2 RB, an RAT3 RB, and an RAT4 RB can be additionally connected between the BS and the UE in addition to the RAT1 RB, and the BS can send the packet to the UE through at least one of the RAT1 RB, the RAT2 RB, the RAT3 RB, and the RAT4 RB. In contrast, an uplink packet transmitted by the UE can be transmitted to the BS through at least one of the RAT1 RB, the RAT2 RB, the RAT3 RB, and the RAT4 RB, and the BS sends the packet to the peer entity through the S1 bearer, the S5/S8 bearer, and the external bearer.

In this case, the RAT1 RB, the S1 bearer, the S5/S8 bearer, and the external bearer can be generated through an existing procedure. In this case, the BS and the UE can perform connection establishment on the RAT2 RB, the RAT3 RB, and the RAT4 RB, that is, HetNet RATs, through an L3C1 message and perform transmission and reception by distributing uplink and/or downlink traffic to the RAT2 RB, the RAT3 RB, and the RAT4 RB. In the state in which the connection establishment for the HetNet RATs has been completed, the BS and the UE can check the connection state of the HetNet RATs while periodically or aperiodically exchanging packets for continuously checking the validity of connection with the HetNet RATs.

If it is determined that some interference or overload is generated in a cell (or carrier) based on RAT1, the RAT1 infra-network can detour some of traffic or the entire traffic to a cell based on the HetNet RATs abased on the information about the UE. For example, if UE is placed in a cell based on HetNet RAT to which radio access is possible, while moving at low speed based on UE mobility information, and it is determined that radio resources available in the cell based on HetNet RAT satisfy Quality of Service (QoS) necessary for the UE, the BS can detour some of traffic or the entire traffic to the cell based on HetNet RAT in order to avoid interference or reduce a load of the cell based on HetNet RAT1.

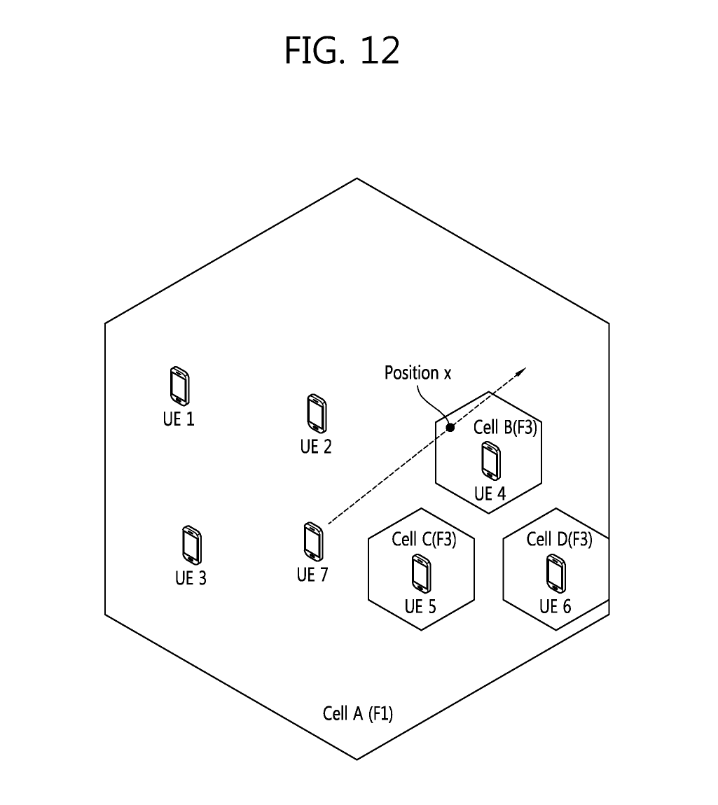

FIG. 12 shows an example in which small cells based on RAT different from that of a macro cell are deployed in one macro cell. In this case, radio resource management according to the framework of FIG. 7 can be applied to the example of FIG. 12.

Referring to FIG. 12, a total of UE1, UE2, UE3, UE4, UE5, UE6, and UE7 are present. From among them, the UE1, the UE2, and the UE3 are placed only in the area of a cell A, and the UE4, the UE5, and the UE6 are placed in the respective areas of a cell B, a cell C, and a cell D, that is, small cells. The UE7 passes through the area of the cell B while moving in the area of the cell A. In this case, a radio resource management procedure according to the present invention can be performed as follows.

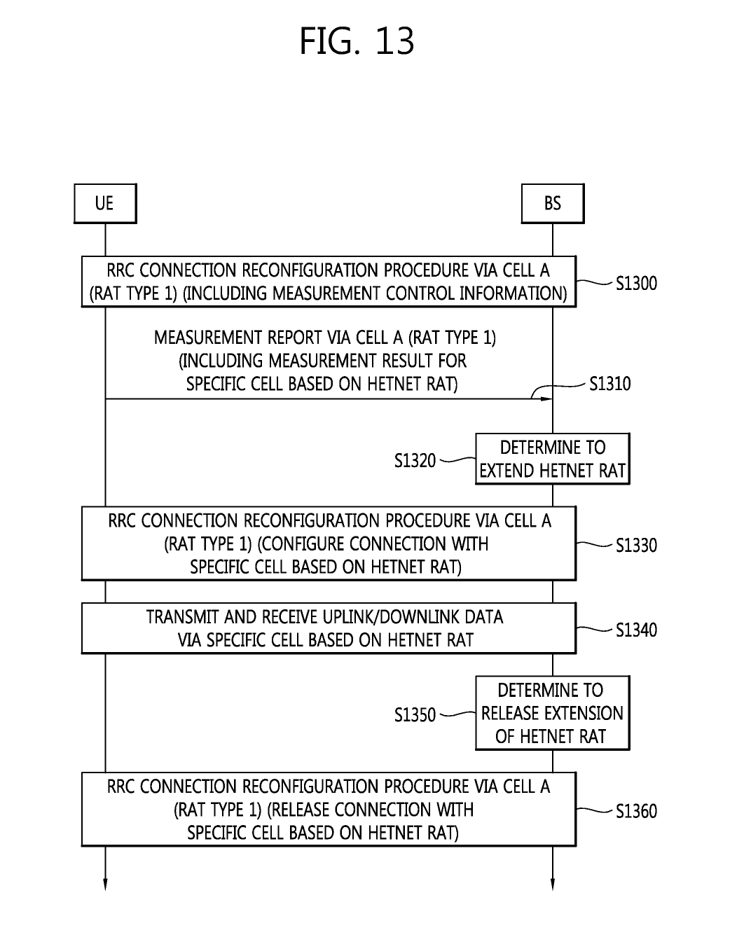

FIG. 13 is a flowchart illustrating a radio resource management procedure in accordance with an embodiment of the present invention.

Referring to FIG. 13, the UE, together with a BS, performs an RRC connection reconfiguration procedure through the cell A of RAT type 1 at step S1300. That is, the BS, together with the UE, performs the RRC connection reconfiguration procedure using the cell A of RAT type 1 as a serving cell. The RRC connection reconfiguration procedure includes a process in which the BS sends an RRC connection reconfiguration message1 to the UE and the UE sends an RRC connection reconfiguration completion message1 to the BS. In this case, the RRC connection reconfiguration message1 includes measurement control information. The measurement control information is information that requests a measurement report from the UE. Alternatively, the measurement control information may be information that requests the UE to report at least one of an accessible radio state and redundant resources. The BS can send the RRC connection reconfiguration message, including the measurement control information, to all pieces of UEs connected to the cell A. For example, if the cell A is a macro cell, the BS may previously check rough information about the location of UE within the cell A and the cell location and cell area of a small cell (or macro cell) that geographically neighbors the cell A or that is placed within the cell A and may send the RRC connection reconfiguration message, including the measurement control information, to the UE, if necessary.

The UE performs a measurement report to the BS at step S1310. The measurement report can include a measurement result for a cell based on HetNet RAT (e.g., RAT type 2). For example, the measurement report can include a measurement result for a certain cell based on HetNet RAT (e.g., RAT type2) not RAT type1, used by the cell A to which the UE is not connected, or a specific cell (e.g., the cell B, the cell C, or the cell D). For another example, the measurement report can include at least one of an accessible radio state and redundant resources of the UE. For example, the UE can perform measurement based on the measurement control information and report information about whether the UE can access a specific small cell based on HetNet RAT and a load of the small cell to the BS. The BS can continue to collect the measurement report. Furthermore, if the UE has already been connected to the specific small cell and connection with the specific small cell is unstable, the measurement report may include information indicating that connection with the specific small cell is unstable.

After performing measurement, the UE reports the measurement result to the BS of a serving cell. This report is called a measurement report. The measurement report includes a periodic report and an event-triggered report.

The measurement report can be performed through a measurement report message. The measurement report message can include a Reference Signal Received Power (RSRP) value, a Reference Signal Received Quality (RSRQ) value, a Physical Cell ID (PCI), a Cell Global ID (CGI), etc. Alternatively, the measurement report message can include at least one of the accessible radio state and the redundant resources. For example, the measurement report of the UE4 can indicate that the UE4 can access the cell B, that is, a small cell, and a load of the cell B is 20%. For another example, the measurement report of the UE5 can indicate that the UE5 is unable to access the cell C, that is, a small cell. For yet another example, the measurement report of the UE6 can indicate that the UE6 can access the cell D, that is, a small cell, and a load of the cell D is 30%. For still another example, if the UE7 has mobility, the measurement report of the UE7 can indicate that the UE7 can access the cell B at a specific location and a load of the cell B is 20%. The BS can determine whether or not to perform the switching or distribution of traffic on the UE based on the above measurement report. Alternatively, if the mobility of UE is high, the BS may reduce priority of the distribution of traffic over the UE or may not perform the distribution of traffic on the UE. In this case, the BS can manage the above resource usage information.

The BS determines the extension of HetNet RAT based on the measurement report at step S1320. Here, the extension of HetNet RAT may mean that the BS determines to perform HetNet RAT bearer connection based on the measurement report or determines the distribution of traffic over a specific cell based on the HetNet RAT. For example, if the cell A now connected to the BS is in an overload state or severe interference is generated in the cell A now connected the BS, the BS can determine to configure bearer connection with the UE4 or the UE6 for the cell B or the cell D based on HetNet RAT.

The BS, together with the UE, performs an RRC connection reconfiguration procedure through the cell A of RAT type 1 at step S1330. The RRC connection reconfiguration procedure includes a process in which the BS sends an RRC connection reconfiguration message2 to the UE and the UE sends an RRC connection reconfiguration completion message2 to the BS. The RRC connection reconfiguration message2 can include HetNet RAT extension request information. The UE can configure the HetNet RAT bearer connection in the UE stage based on the HetNet RAT extension request information. Here, the term ‘bearer’ can include a Radio Bearer (RB). In other words, the RRC connection reconfiguration message2 can include information about connection configuration for a specific cell based on HetNet RAT. The UE can connect to the specific cell based on the HetNet RAT based on the information about connection configuration for a specific cell based on HetNet RAT. For example, the specific cell based on HetNet RAT can be added to the UE as a secondary component carrier.

The configuration of the HetNet RAT bearer connection can be triggered through the cell A of RAT type1. The BS can change or distribute traffic for the UE through RAT type2 radio connection (e.g., through the specific cell). Here, signal processing through the cell A of RAT type1 can be continuously performed through the cell A.

The UE and the BS can transmit and receive uplink/downlink data via the HetNet RAT bearer (or the specific cell based on HetNet RAT) at step S1340. In this case, if an already connected cell A is in an overload state or is subject to severe interference, the UE and the BS can meet load balancing or avoid interference by distributing or changing the traffic through the HetNet RAT.

The BS determines the release of the HetNet RAT extension, if necessary at step S1350. Here, the release of the HetNet RAT extension may mean that HetNet RAT bearer connection is released or connection with the specific cell based on HetNet RAT is released. For example, if a load of the cell A to which UE is connected is a specific threshold or lower or the connection with the cell B is unstable, such as that the UE deviates from the coverage of the cell B, the BS can determine to release HetNet RAT bearer connection (i.e., connection with the specific cell based on HetNet RAT).

The BS, together with the UE, performs an RRC connection reconfiguration procedure through the cell A of RAT type 1 at step S1360. The RRC connection reconfiguration procedure includes a process in which the BS sends an RRC connection reconfiguration message3 to the UE and the UE sends an RRC connection reconfiguration completion message3 to the BS. The RRC connection reconfiguration message3 can include HetNet RAT extension release request information. The UE can release the HetNet RAT bearer connection in the UE stage based on the HetNet RAT extension release request information. Alternatively, the RRC connection reconfiguration message3 can include the specific cell connection release request information based on HetNet RAT. The UE can release the connection with the specific cell based on the HetNet RAT on the basis of the specific cell connection release request information based on the HetNet RAT. The release of the HetNet RAT bearer connection can be triggered through the cell A of RAT type1.

Although steps S1350 and S1360 have been illustrated as being performed after step S1340 in FIG. 13, steps 1350 and S1360 may be omitted, if necessary.

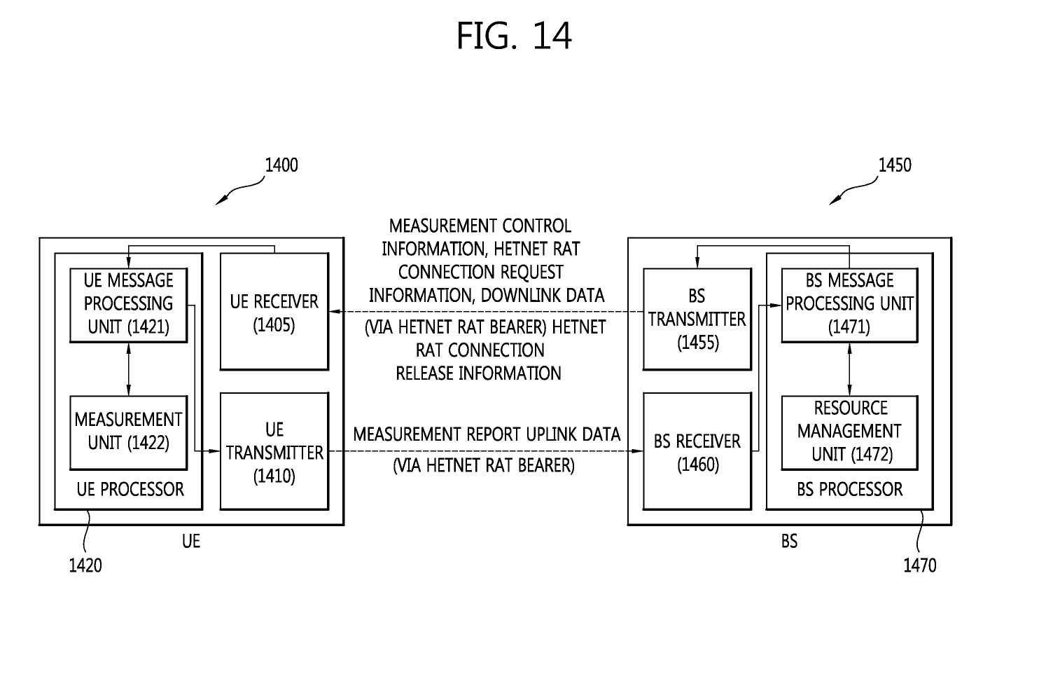

FIG. 14 is a block diagram of UE 1400 and a BS 1450 for performing radio resource management in accordance with an embodiment of the present invention.

Referring to FIG. 14, the UE 1400 includes a UE receiver 1405, a UE processor 1420, and a UE transmitter 1410. The UE processor 1420 includes a UE message processing unit 1421 and a measurement unit 1422.

The UE receiver 1405 receives an RRC connection reconfiguration message, including measurement control information, from the BS 1450. The measurement control information can include at least a piece of information about the accessible radio state report and redundant resource report of the UE 1400.

Furthermore, the UE receiver 1405 receives an RRC connection reconfiguration message, requesting to configure HetNet RAT bearer connection with the UE 1400, from the BS 1450.

The UE measurement unit 1422 performs measurement on neighboring cells and generates a measurement result. In this case, the UE measurement unit 1422 may perform measurement on specific cells based on the measurement control information. The UE measurement unit 1422 can generate a measurement result for a cell based on HetNet RAT. In this case, the UE measurement unit 1422 may generate the measurement result, including information about whether or not a specific small cell based on HetNet RAT can be and information about a load of the small cell.

The UE transmitter 1410 sends a measurement report, including the measurement result, to the BS 1450.

The UE message processing unit 1421 analyzes or interprets the syntax of the information or message received from the UE receiver 1405.

The UE message processing unit 1421 can analyze the RRC connection reconfiguration message including the measurement control information and analyze the measurement control information included in the message.

Furthermore, the UE message processing unit 1421 can analyze the RRC connection reconfiguration message that requests to configure HetNet RAT bearer connection with the UE 1400 and can configure the HetNet RAT bearer connection in the UE (1400) stage.

Furthermore, the UE message processing unit 1421 can generate an RRC connection reconfiguration completion message and send the RRC connection reconfiguration completion message to the BS 1450 through the UE transmitter 1410.

The UE receiver 1405 can receive some of or the entire traffic (i.e., downlink data) for the UE 1400 from the BS 1450 through the HetNet RAT bearer. For example, the UE message processing unit 1421 can add the cell based on HetNet RAT as a secondary component carrier, and the UE receiver 1405 can receive some of or the entire traffic from the BS 1450 through the secondary component carrier. Furthermore, the UE transmitter 1410 may send some of or the entire uplink data to the BS 1450 through the HetNet RAT bearer.

Furthermore, the UE receiver 1405 can receive an RRC connection reconfiguration message that requests the release of the HetNet RAT bearer connection from the BS 1450. In this case, the UE message processing unit 1421 can analyze the RRC connection reconfiguration message that requests the release of the HetNet RAT bearer connection and release connection with the already configured HetNet RAT bearer based on the analyzed RRC connection reconfiguration message. For example, the UE message processing unit 1421 can remove the cell based on HetNet RAT from a secondary component carrier.

The BS 1450 includes a BS transmitter 1455, a BS receiver 1460, and a BS processor 1470. The BS processor 1470 includes a BS message processing unit 1471 and a resource management unit 1472.

The BS transmitter 1455 sends an RRC connection reconfiguration message, including measurement control information, to the UE 1400. The measurement control information can include at least a piece of information about the accessible radio state report and redundant resource report of the UE 1400.

The BS receiver 1460 receives a measurement report, including the measurement result, from the UE 1400. The BS receiver 1460 can receive the measurement report, including the measurement result for a cell based on HetNet RAT, from the UE 1400. For example, the BS receiver 1460 can receive the measurement report including the measurement result, including information about whether or not a specific small cell based on HetNet RAT can be accessed and information about a load of the small cell, from the UE 1400.

The resource management unit 1472 manages radio resources and determines whether or not to configure HetNet RAT bearer connection with the UE 1400. The resource management unit 1472 can manage information about frequency of resources usage, such as that of Table 1. The resource management unit 1472 can determine whether or not to configure HetNet RAT bearer connection with the UE 1400 based on the measurement report. In this case, the resource management unit 1472 can configure the HetNet RAT bearer connection in the BS (1450) stage. For example, if it is determined that a serving cell to which the UE 1400 is already connected is in an overload state or interference has generated in the serving cell, the resource management unit 1472 can determine to configure HetNet RAT bearer connection with the UE 1400.

Furthermore, the resource management unit 1472 can determine to release the HetNet RAT bearer connection from the UE 1400. In this case, the resource management unit 1472 can release the HetNet RAT bearer connection in the BS (1450) stage.

The BS message processing unit 1471 interprets or analyzes information or a message received from the BS receiver 1460.

The BS message processing unit 1471 can analyze the measurement report and interpret or analyze the measurement result included in the message.

The BS message processing unit 1471 can generate an RRC connection reconfiguration message including measurement control information and send the generated RRC connection reconfiguration message to the UE 1400 through the BS transmitter 1460. Furthermore, the BS message processing unit 1471 can generate an RRC connection reconfiguration message that requests the connection of the HetNet RAT bearer configuration for the UE 1400 and send the generated RRC connection reconfiguration message to the UE 1400 through the BS transmitter 1460.

Furthermore, the reception unit 1460 can receive an RRC connection reconfiguration completion message, corresponding to each RRC connection reconfiguration message, from the BS 1450.

The BS transmitter 1405 can send some of or the entire traffic (i.e., downlink data) for the UE 1400 to the UE 1400 through the HetNet RAT bearer. For example, the BS message processing unit 1471 can add the cell based on HetNet RAT as a secondary component carrier, and the BS transmitter 1455 can send some of or the entire traffic to the UE 1400 through the secondary component carrier. Furthermore, the BS receiver 1455 may receive some of or the entire uplink data from the UE 1400 through the HetNet RAT bearer.

Furthermore, the BS message processing unit 1471 can generate an RRC connection reconfiguration message that requests the release of the HetNet RAT bearer connection with the UE 1400 and send the generated RRC connection reconfiguration message to the UE 1400 through the BS transmitter 1460.

In accordance with the present invention, radio resources can be efficiently managed in a new mobile communication system environment. The present invention can be applied to an HeNet and a cloud BS system.

In accordance with the present invention, if overload or interference is generated in a serving cell, some of or the entire traffic is transmitted through a cell based on HetNet RAT, if necessary. Accordingly, load balancing can be achieved, and interference can be avoided.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A wireless communication system for supporting heterogeneous (HetNet) Radio Access Technology (RAT), comprising:
an anchor system being a RAT system that is a criterion and for sending traffic to user equipment, checking information about at least one HetNet RAT system available for the user equipment, and controlling a connection configuration between the at least one HetNet RAT system and the user equipment; and
the at least one HetNet RAT system for configuring connection with the user equipment based on control of the connection configuration of the anchor system and sending some of or an entire traffic for the user equipment, to the user equipment.

2. The wireless communication system of claim 1, wherein:
the RAT system that is a criterion is a 3^{rd} Generation Partnership Project (3GPP) Long-Term Evolution (LTE) system, and
the anchor system controls the connection configuration between the at least one HetNet RAT system and the user equipment through a Radio Resource Control (RRC) connection reconfiguration procedure with the user equipment.

3. The wireless communication system of claim 2, wherein:
the user equipment sends a measurement report, comprising a measurement result for cells based on the at least one HetNet RAT, to the anchor system, and
the anchor system controls the connection configuration between the at least one HetNet RAT system and the user equipment based on the measurement report.

4. The wireless communication system of claim 3, wherein:
the anchor system sends measurement control information, requesting at least one of an accessible radio state report on the cells based on the at least one HetNet RAT, and a redundant resource report on the cells based on the at least one HetNet RAT, to the user equipment, and
the user equipment generates the measurement report based on the measurement control information and sends the generated measurement report to the anchor system.

5. The wireless communication system of claim 1, wherein the traffic is transmitted to the user equipment using at least one of carriers used in the anchor system as a primary component carrier and at least one of carriers used in the at least one HetNet RAT system as a secondary component carrier.

6. User equipment supporting multiple carriers, comprising:
a reception unit for receiving a Radio Resource Control (RRC) connection reconfiguration message, comprising measurement control information, from a base station;
a message processing unit for analyzing the measurement control information;
a measurement unit for generating a measurement result for a cell based on heterogeneous (HetNet) Radio Access Technology (RAT) regarding the base station; and
a transmission unit for sending a measurement report, comprising the measurement result, to the base station,
wherein the reception unit receives an RRC connection reconfiguration message, requesting to configure HetNet RAT bearer connection with the user equipment, from the base station,
the message processing unit configures the HetNet RAT bearer connection in the user equipment stage, and
the reception unit receives some of or an entire traffic for the user equipment, from the base station through the HetNet RAT bearer.

7. The user equipment of claim 6, wherein the reception unit receives the RRC connection reconfiguration message comprising the measurement control information comprising information that requests at least one of an accessible radio state report on the cell based on the HetNet RAT and a redundant resource report on the cell based on the HetNet RAT regarding the user equipment.

8. The user equipment of claim 7, wherein the measurement unit generates the measurement result comprising information about whether a specific small cell based on HetNet RAT is accessible or not and about a load of the small cell.

9. The user equipment of claim 6, wherein the reception unit receives an RRC connection reconfiguration message, requesting to release the HetNet RAT bearer connection, from the base station.

10. The user equipment of claim 9, wherein the message processing unit releases the configured HetNet RAT bearer connection in response to the RRC connection reconfiguration message that requests to release the HetNet RAT bearer connection.

11. A method of managing radio resources in a base station supporting multiple carriers, the method comprising:
sending a Radio Resource Control (RRC) connection reconfiguration message, comprising measurement control information, to user equipment;
receiving a measurement report, comprising a measurement result for a heterogeneous (HetNet) Radio Access Technology (RAT) cell, from the user equipment;
determining to configure HetNet RAT bearer connection with the user equipment based on the measurement report;
sending an RRC connection reconfiguration message, requesting to configure the HetNet RAT bearer connection, to the user equipment; and
sending some of or an entire traffic for the user equipment to the user equipment through the HetNet RAT bearer.

12. The method of claim 11, wherein the measurement control information comprises information requesting at least one of an accessible radio state report on the HetNet RAT cell and a redundant resource report on the HetNet RAT cell regarding the user equipment.

13. The method of claim 12, wherein the measurement result comprises information about whether a specific small cell based on HetNet RAT is accessible or not and about a load of the small cell.

14. The method of claim 13, wherein if a serving cell to which the user equipment is already connected is in an overload state or interference is generated in the serving cell, the HetNet RAT bearer connection with the user equipment is determined to be configured.

15. The method of claim 11, further comprising:
determining to release the HetNet RAT bearer connection with the user equipment; and
sending an RRC connection reconfiguration message, requesting to release the HetNet RAT bearer connection, to the user equipment.

16. A method of managing radio resources in user equipment supporting multiple carriers, the method comprising:
receiving a Radio Resource Control (RRC) connection reconfiguration message, comprising measurement control information, from a base station;
sending a measurement report, comprising a measurement result for a cell based on heterogeneous (HetNet) Radio Access Technology (RAT), to the base station;
receiving an RRC connection configuration message, requesting to configure HetNet RAT bearer connection with the user equipment, from the base station;
configuring the HetNet RAT bearer connection in the user equipment stage; and
receiving some of or an entire traffic for the user equipment from the base station through the HetNet RAT bearer.

17. The method of claim 16, wherein the measurement control information comprises information that requests at least one of an accessible radio state report on the cell based on the HetNet RAT and a redundant resource report on the cell based on the HetNet RAT regarding the user equipment.

18. The method of claim 17, wherein the measurement result comprises information about whether a specific small cell based on HetNet RAT is accessible or not and about a load of the small cell.

19. The method of claim 16, further comprising receiving an RRC connection reconfiguration message, requesting to release the HetNet RAT bearer connection, from the base station.

20. The method of claim 19, further comprising releasing the configured HetNet RAT bearer connection in response to the RRC connection reconfiguration message that requests to release the HetNet RAT bearer connection.
